(19) United States
(12) Patent Application Publication
(10) Pub. No.: US 2016/0154148 A1
(43) Pub. Date: Jun. 2, 2016

(54) BEADED RETROREFLECTIVE ARTICLE WITH MULTILAYER SEAL FILM

(71) Applicant: 3M INNOVATIVE PROPERTIES COMPANY, Saint Paul, MN (US)

(72) Inventors: Reema Chatterjee, Woodbury, MN (US); Jeffrey O. Emslander, Stillwater, MN (US); Danny L. Fleming, Stillwater, MN (US)

(21) Appl. No.: 14/900,796

(22) PCT Filed: Jun. 11, 2014
(86) PCT No.: PCT/US2014/041839

§ 371 Date: Dec. 22, 2015

Related U.S. Application Data
(60) Provisional application No. 61/838,550, filed on Jun. 24, 2013.

(51) Int. Cl. G02B 5/128; G02B 1/18

(52) U.S. Cl. CPC G02B 5/128; G02B 1/18

(57) ABSTRACT

The present disclosure generally relates to retroreflective articles and methods of making retroreflective articles including a beaded retroreflective article and a multilayer seal film adjacent thererto. The multilayer film includes a polymeric sealing layer and an adhesive layer. In some embodiments, the multilayer film includes a release liner. In some embodiments, seal legs extend through all layers of the multilayer film In some embodiments, the retroreflective article is retroreflective sheeting. In some embodiments, the retroreflective sheeting and the multilayer film are laminated, embossed, and/or sealed in a single processing step.

### TECHNICAL FIELD

This disclosure relates generally to retroreflective articles (e.g. sheeting) that include beaded sheeting and a multilayer seal film. This disclosure also generally relates to methods of making such articles.

### BACKGROUND

Retroreflective articles are characterized by the ability to redirect light incident on the material back toward the originating light source. This property has led to the widespread use of retroreflective articles in sheeting used in, for example, traffic and personal safety uses. Retroreflective sheeting is commonly employed in a variety of traffic control articles, for example, road signs, barricades, license plates, pavement markers and marking tape, as well as retroreflective tapes for vehicles and clothing.

One type of retroreflective sheeting is microsphere-based sheeting, sometimes referred to as “beaded” sheeting. Beaded sheeting includes a multitude of microspheres typically at least partially embedded in a binder layer and having associated specular or diffuse reflecting materials (e.g., pigment particles, metal flakes or vapor coats, etc.) to retroreflect incident light.

In many instances, it is desirable to seal the retroreflective sheeting and thereby to protect the beads from environmental degradation. Inclusion of a sealing layer in the sheeting prevents or limits entry of soil or moisture into the sheeting. Some exemplary methods of applying of a sealing layer are described in U.S. Pat. Nos. 7,329,447; 7,611,251; 5,784,197; 4,025,159 (disclosing use of electron beam radiation); U.S. Pat. No. 5,706,132 (use of thermal bonding or radio frequency welding); PCT Publication WO 2011/152977 (describing multi-layer sealing films for prismatic retroreflective sheeting); and. U.S. Pat. No. 6,224,792 (hermetic encapsulation by the sealing layer).

After the sealing process is complete, the sealed back side is then coated with adhesive. Afterwards, a release liner is placed over the adhesive coating. In some instances, the adhesive is coated on a release liner, and the release liner is then laminated to the backside of the retroreflective sheeting.

### SUMMARY

The inventors of the present disclosure recognized that the existing method of sealing, adhesive coating, and release liner coating retroreflective sheeting requires numerous steps. The inventors also recognized that manufacturing efficiency and cost-saving could be achieved by reducing the number of separate steps in manufacturing these articles. To address these problems, the inventors of the present disclosure invented various processes described herein that eliminate the separate adhesive lamination step in making beaded retroreflective articles. At least some of these processes enable direct lamination of a seal film with adhesive (and optionally a release liner) to retroreflective articles in a single step.

Additionally, the inventors of the present disclosure recognized that the existing methods of sealing beaded retroreflective sheeting create air bubbles between the adhesive and the substrate to which the retroreflective sheeting is attached. The inventors of the present application recognized that creating retroreflective sheeting with the ability to bleed or remove trapped gas or air bubbles could improve the overall performance (e.g., durability, appearance under diffuse light, etc) of the sheeting. The inventors of the present disclosure recognized that one method to create retroreflective sheeting with air bleed properties involves the inclusion of a multilayer film (including a sealing layer and an adhesive and optionally a release liner) through which seal legs and/or channels are present.

Some embodiments of the present disclosure relate to a retroreflective article, comprising beaded retroreflective sheeting including a plurality of microspheres; and a multilayer film comprising a polymeric sealing layer and an adhesive layer, the multilayer film adjacent to the beaded retroreflective sheeting; and seal legs extending through all layers of the multilayer film.

In some embodiments, the microspheres are at least one of exposed, embedded, and encapsulated. In some embodiments, the seal legs extend between the multilayer film and the beaded retroreflective sheeting (e.g., the structured surface of the sheeting). Some embodiments further include an air interface between the beaded retroreflective sheeting and the multilayer film.

Some embodiments further include a release liner layer adjacent to the adhesive layer. In some embodiments, the release liner is polymeric. In some embodiments, the release liner is comprised of two layers, a release layer facing the adhesive layer and an outer layer having a composition to reduce blocking. In some embodiments, the release liner comprises a release layer comprised of very low density polyethylene, and an outer layer comprised of a polyethylene that is not very low density polyethylene. In some embodiments, the outer layer includes at least one of polypropylene, polyethylene, or polyethylene terephthalate.

In some embodiments, the polymeric sealing layer includes at least one of a thermoplastic polymer, a heat activated polymer, a polymer composition curable by ultraviolet radiation, and a polymer composition curable by ionizing radiation. In some embodiments, the polymeric sealing layer includes a thermoplastic composition comprising at least 50 weight percent reaction products of an alkylene monomer and reaction products of at least one non-acidic polar monomer, and the thermoplastic composition comprises a polyalkylene modified by an acid, an anhydride, carbon monoxide or a combination thereof.

In some embodiments, the microspheres or a spacing layer adjacent to the microspheres are at least partially coated with a specular reflective coating.

Other embodiments relate to a process of making a retroreflective article, comprising laminating a multilayer film adjacent to beaded retroreflective sheeting and thereby forming a plurality of seal legs that extend through all layers of the multilayer film; wherein the multilayer film comprises a polymeric sealing layer and an adhesive layer.

In some embodiments, laminating the multilayer film includes bonding the multilayer film to the beaded retroreflective sheeting by at least one of ultrasonic welding, radio frequency welding, thermal bonding, ultraviolet radiation, and electron beam radiation. Some embodiments further comprise using solution casting, extrusion casting, blown film extrusion, or any combination thereof to form the multilayer film. In some embodiments, extrusion casting involves coextrusion casting. In some embodiments, blown film extrusion involves blown film coextrusion.

In some embodiments, the microspheres in the beaded retroreflective sheeting are at least one of embedded, encapsulated, and exposed. In some embodiments, the seal legs extend between the multilayer film and the beaded retroreflective sheeting. Some embodiments involve laminating the multilayer film adjacent to the beaded retroreflective sheeting to form an air interface between at least some of the microspheres in the beaded retroreflective sheeting and the multilayer film.

In some embodiments, the multilayer film further comprises a release liner layer adjacent to the adhesive layer. In some embodiments, the release liner layer is polymeric. In some embodiments, the release liner layer is comprised of two layers, a release layer facing the adhesive layer and an outer layer having a composition to reduce blocking. In some embodiments, the release liner layer comprises a release layer comprised of very low density polyethylene, and an outer layer comprised of a polyethylene that is not very low density polyethylene. In some embodiments, the outer layer includes at least one of polypropylene, polyethylene, or polyethylene terephthalate.

In some embodiments, the polymeric sealing layer includes at least one of a thermoplastic polymer, a heat activated polymer, a polymer composition curable by ultraviolet radiation, or a polymer composition curable by ionizing radiation. In some embodiments, the polymeric sealing layer includes a thermoplastic composition comprising at least 50 weight percent reaction products of an alkylene monomer and reaction products of at least one non-acidic polar monomer, and the thermoplastic composition comprises a polyalkylene modified by an acid, an anhydride, carbon monoxide, or a combination thereof.

In some embodiments, the microspheres or a spacing layer adjacent to the microspheres are at least partially coated with a specular reflective coating.

Some embodiments further involve co-extruding the sealing layer and adhesive layer in a single step to form the multilayer film.

Other features and advantages of the present application are described or set forth in the following detailed specification that is to be considered together with the accompanying drawings.

### BRIEF DESCRIPTION OF DRAWINGS

The disclosure may be more completely understood in consideration of the following detailed description of various embodiments of the disclosure in connection with the accompanying drawings.

FIG. 1 is a plan view of exemplary beaded sheeting showing an exemplary diamond-shaped seal pattern, not drawn to scale.

FIG. 2 is a cross-sectional representation of an exemplary embodiment of beaded retroreflective sheeting according to the present disclosure, not drawn to scale.

FIG. 3 is a cross-sectional representation of an exemplary embodiment of beaded retroreflective sheeting according to the present disclosure, not drawn to scale.

### DETAILED DESCRIPTION

In the following detailed description, reference may be made to the accompanying drawing that forms a part hereof and in which is shown by way of illustration one exemplary specific embodiment. It is to be understood that other embodiments are contemplated and may be made without departing from the scope or spirit of the present disclosure.

The concepts described herein are applicable to any sealed and adhesive-coated retroreflective article having a plurality of microspheres or beads. The following discussion will relate to retroreflective sheeting (one exemplary set of embodiments of these retroreflective articles). But the disclosure is meant to include non-sheeting retroreflective articles as well.

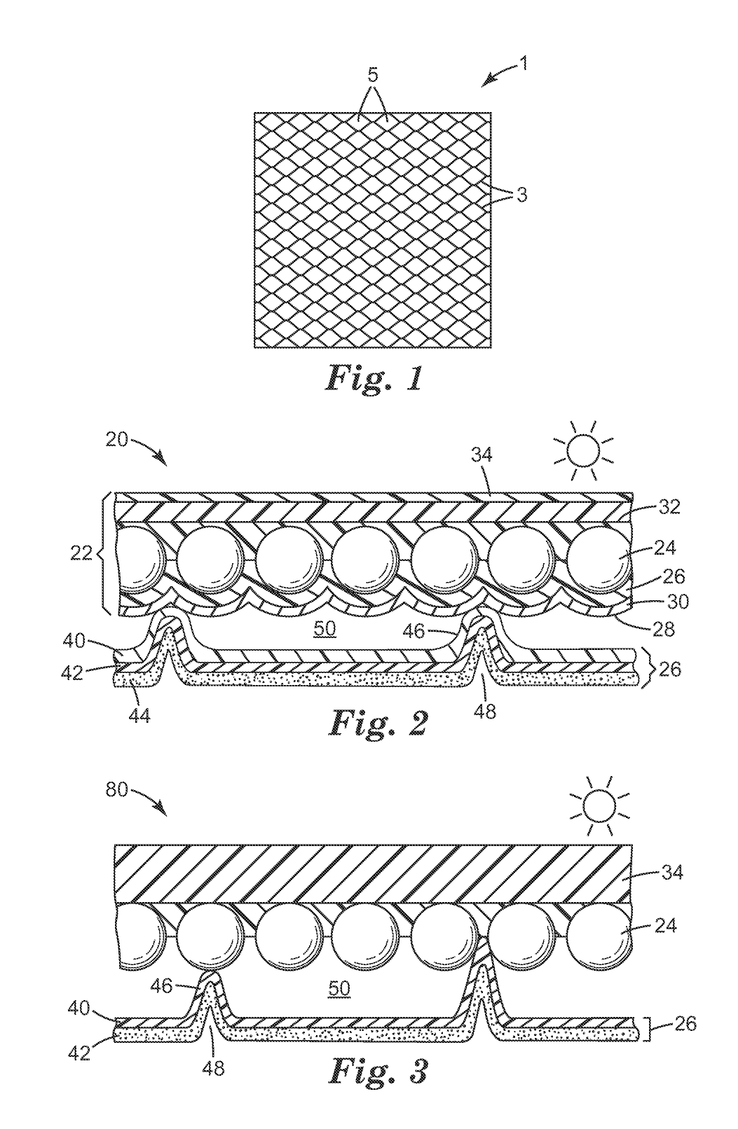

FIG. 1 shows a top view of an exemplary retroreflective article 1 in which a seal pattern 3 is visible. Seal pattern 3 forms cells 5 in a diamond-shaped grid pattern. The specific seal pattern shown in FIG. 1 is merely exemplary. The cells may be in any of a variety of shapes, such as triangles, hexagons, diamonds, rectangles, parallelograms, other polygons or curved shapes. The seal pattern may be any arrangement or pattern (regular or random). In some embodiments, the seal pattern includes lines (straight or curved) that form cells.

Seal pattern 3 includes a plurality of individual seal legs that extend between the microspheres in the beaded retroreflective sheeting and a multilayer seal film. In some embodiments, these seal legs form one or more cells 5. In some embodiments, a low refractive index material (e.g., a gas, air, aerogel, or an ultra low index material described in, for example, U.S. Patent Publication Nos. 2010-0265584) can be enclosed in each cell 5. The presence of the low refractive index material creates a refractive index differential between the plurality of microspheres and the low refractive index material. This permits total internal reflection at the surfaces of the microspheres. In embodiments where air is used as the low refractive index material, the interface between the air and the microspheres is often referred to as an air interface.

FIG. 2 shows an exemplary embodiment of a retroreflective article 20 consistent with the teachings herein. Retroreflective article 20 includes beaded retroreflective sheeting 22 adhered, bonded, and/or adjacent to a multilayer film 26. Beaded retroreflective sheeting 22 includes a plurality of microspheres 24 adjacent to a spacing layer 26 adjacent to a specular reflective coating or layer 30, all which assist in forming a structured surface 28 that is opposite a major surface 32 (sometimes referred to as a front side surface) of retroreflective sheeting 22. In the embodiment shown in FIG. 2, retroreflective sheeting 22 includes a multilayer topfilm 34. Multilayer topfilm is optional, and can be a single layer topfilm. Multilayer film 26 includes a sealing layer 40 and an adhesive layer 44. Multilayer film 26 is adhered and/or bonded to the structured surface 28 and/or to the specular reflective coating 30. The areas in which multilayer film 26 is adhered and/or or bonded (e.g., by embossing) to structured surface 28 form seal legs 46, and in some instances, channels 48.

In some embodiments, seal legs 46 are disposed between multilayer film 26 (e.g., sealing layer 40) and structured surface 28. Seal legs 46 bond multilayer film 26 to structured surface 28. In some embodiments, seal legs 46 assist in, for example, creating and maintaining a cell, air gap, and/or air interface 50 between structured surface 28 and multilayer film 26. In some embodiments, the seal legs assist in preserving the air spaces around the microspheres. In some embodiments, the microspheres in each cell are hermetically encapsulated by the sealing layer 40 of multilayer film 26 by the application of heat and pressure or other techniques, see e.g., U.S. Pat. No. 6,224,792, incorporated herein in its entirety. In other embodiments, the seal legs help to protect the microspheres from environmental degradation by preventing or limiting entry of soil or moisture into the cells. In some embodiments, the seal legs do not form cells or air interfaces.

In the embodiment shown in FIG. 2, seal legs 46 include all of the layers of multilayer film 26. This is because the process of bonding and/or embossing the multilayer film is applied to all layers of the multilayer film such that the seal pattern is, for example, pressed through all the layers of the multilayer film as shown by the shape of the channels 48 and/or seal legs 46. In some embodiments, when the front side surface of the retroreflective article is viewed from above (in top view), seal legs 46 form an overall seal pattern in the final retroreflective article that, in some embodiments, may be visible to the naked eye.

Where present, the seal pattern can be any desired pattern, design, or arrangement. In some embodiments, the pattern or design or arrangement is random. In some embodiments, the pattern or design or arrangement is organized or repeating. Some exemplary seal patterns include those described in, for example, PCT Patent Application No. PCT/US2010/031298 (see, e.g., FIGS. 3, 4, 6, 8, 9 and paragraphs [0063], [0065], [00144], [00159], and [00160]), the entirety of which is incorporated herein by reference.

In some embodiments, the adherence or bond between multilayer film 26 and structured surface 28 forms one or more channels 48, which are each a physical groove or depression in at least a portion of the multilayer film. Where channels 48 are present, they can permit or facilitate air egress (which may be called fluid exhaust or air bleed) from beneath the retroreflective sheeting when the sheeting is applied to a substrate. This can help in reducing deformities in the applied sheeting such as air pockets, bubbles, or wrinkles. In some embodiments, the adhesive layer is not so aggressive or tacky that the adhesive in the channels bonds quickly to a substrate interfering with air egress (or fluid exhaust) from between the retroreflective article being applied and the substrate to which it is being adhered. In some embodiments, channels 48 are continuous (i.e., connected to at least one other channel). In some embodiments, each channel 48 is connected to many channels. In some embodiments, channels 48 are all connected. In some embodiments, the channels are not connected. Some exemplary channel depth ranges are 3-45 micrometers (m), 5-25 μm, and not more than 10 μm deep. Some exemplary channel width ranges are 15-250 μm and 15-30 μm. In some embodiments where channels are formed for the purpose of fluid exhaust or air egress, the wider the channels are, the less deep they have to be, and vice versa.

In at least some embodiments, the areas of the multilayer film into which channels 48 are impressed do not recover their original or flat shape, and channels 48 remain present over time. In some embodiments, the areas of the release liner layer into which channels are impressed recover their original or flat shape after some amount of time has passed.

FIG. 3 shows another exemplary embodiment of a retroreflective article 80 consistent with the teachings herein. The embodiment shown in FIG. 3 is the same as that shown in FIG. 2 except that beaded retroreflective sheeting 22 does not include a spacing layer or specular reflective layer and instead relies on the presence of air interface 50 for retroreflection. Also, top film 34 is a single layer, and multilayer film 26 does not include a release liner.

### Beaded Retroreflective Sheeting

The microspheres used in the articles and methods described herein may include light transmitting or transparent polymeric materials. Microsphere-based sheeting, sometimes referred to as “beaded” sheeting, employs a multitude of microspheres typically at least partially embedded in a binder layer and typically having associated specular or diffuse reflecting materials (e.g., pigment particles, metal flakes or vapor coats, etc.) to retroreflect incident light. Due to the symmetrical geometry of beaded retroreflectors, microsphere based sheeting exhibits about the same total light return regardless of orientation, i.e. when rotated about an axis normal to the surface of the sheeting. Thus, such microsphere-based sheeting has a relatively low sensitivity to the orientation at which the sheeting is placed on a surface. In some embodiments, the microspheres are embedded at a common depth. In some embodiments, the microspheres in the sheeting have approximately the same diameter. In some embodiments, the microspheres have varying diameters. In some embodiments, the microspheres are coated with additional materials. In some embodiments, the microspheres are not coated with other materials.

Various types of microsphere-based retroreflective sheeting are known. The sheeting can be exposed lens sheeting in which a plurality of small, transparent beads or spheres are partially embedded in a bonding layer with a light-reflecting means located behind the beads or spheres. In some embodiments, at least a portion of the lens or spheres sticks out of the binder and is thus “exposed.” Exposed lens sheeting is described in greater detail in, for example, U.S. Pat. No. 2,326,634, which is incorporated herein in its entirety.

The sheeting can be embedded or encapsulated lens sheeting. In some embodiments, the embedded or encapsulated lens sheeting includes a monolayer of microspheres embedded between a transparent bonding layer and a spacing layer; a specularly reflective coating and/or layer adjacent to the spacing; a layer of adhesive adjacent to the reflective layer; and a transparent top layer which forms the exterior front surface. In some embodiments, the microspheres in the embedded lens sheeting are substantially aligned in a common plane. In some embodiments, the microspheres have substantial front surface alignment. One advantage of embedded lens sheeting s that because the microspheres are embedded within the sheeting, incident light rays are focused onto the specularly reflective layer irrespective of whether the front of the sheeting is wet or dry. Embedded lens sheeting is described in greater detail in, for example, U.S. Pat. Nos. 2,948,191, 2,407,680; and 4,367,920, all of which are incorporated herein in their entirety.

Some embodiments include a specular reflective coating, such as a metallic coating, on at least a portion (typically the backside) of the microspheres or on a spacing layer adjacent to the microspheres. In some embodiments, the specular reflective material is a metal. In some embodiments, the metal is vapor-coated onto the spacing layer or microspheres or both. In some embodiments, the specular reflective coating is aluminum vapor coated onto the spacing layer or microspheres or both. The specular reflective coating can be applied by known techniques such as vapor depositing or chemically depositing a metal such as aluminum, silver, or nickel. A primer layer may be applied to the backside of the cube-corner elements to promote the adherence of the metallic coating. Additional information about metalized sheeting, including materials used to make metalized sheeting and methods of making it can be found, for example, in U.S. Pat. Nos. 2,543,800 and 2,713,286, both of which are incorporated herein in their entirety.

### Multilayer Seal Film

The multilayer film includes more than one layer and is attached or adhered to portions of the structured surface formed by the microspheres. The multilayer film includes at least a sealing layer and an adhesive layer. In some embodiments, at least these two layers of the multilayer film are bonded, adhered, and/or embossed to a portion of the structured surface. In some embodiments, the layers of the multilayer film are capable of retaining the deformation from the lamination or embossing tool. The multilayer film may optionally include one or more additional layers, such as, for example, a release liner.

In some embodiments, the multilayer film includes the layers described in, for example, PCT Publication WO 2011/091132 (incorporated herein in its entirety) with specific reference to FIG. 2 and related description as the sealing layer, adhesive layer 28, and the release and liner layers 30 and 32. In some embodiments, the multilayer film includes the layers described in WO 2011/091132 with specific reference to film 20 with a sealing layer instead of a receptor layer 22. In such instances, the sealing layer would be on core layer 24, and primer layer 26 is on core layer 24, opposite sealing layer. Multilayer film 20 from WO 2011/091132 additionally includes: an adhesive layer 28 on primer layer 26 opposite core layer 24; release layer 32 on adhesive layer 28 opposite primer layer 26; and liner layer 32 on release layer 30 opposite adhesive layer 28. The multilayer film can generally be separated along the interface between adhesive layer 28 and release layer 30.

In some embodiments, the multilayer film can be made by methods known in the art such as lamination, co-extrusion and casting a multilayer film from a multilayer die, or co-extrusion through a multilayer blown film die or solvent or extrusion casting the adhesive and seal layers onto a release liner, or any combination of these steps or methods. In some embodiments, the process of making the multilayer film includes using solution casting, extrusion casting, blown film extrusion, or any combination thereof to form the multilayer film. In some embodiments, extrusion casting involves coextrusion casting. In some embodiments, blown film extrusion involves blow film coextrusion.

Various additives such as chain transfer agents, colorants (e.g., dyes), antioxidants, light stabilizers, UV absorbers, processing aids (such as anti-blocking agents), release agents, lubricants, and other additives may be added to the multilayer film 50, see, for example, U.S. Pat. No. 5,450,235, incorporated in its entirety herein.

Sealing Layer

In some embodiments, the sealing layer is a layer within the multilayer film. The sealing layer is generally useful for sealing the multilayer film to or with the structured surface of the microspheres. In some embodiments, sealing layer 40 is sufficiently thick to effectively seal the microspheres in the cells formed by the seal legs but not so thick that it impedes embossing or edge sealing of the retroreflective article. An exemplary thickness range is about 0.03 mm to about 0.3 mm. In some embodiments, no cells are formed, and the sealing layer generally follows the shape or structure of the microspheres.

In some embodiments, the sealing layer includes a polymeric composition that can bond and seal well to the structured surface. In some embodiments, the sealing layer includes at least one of a thermoplastic, a heat-activated polymer, an ultraviolet radiation cured polymer, and/or a polymer cured by ionizing radiation such as, for example, electron beam radiation.

In embodiments where the sealing layer includes a thermoplastic, the sealing layer can include, for example, polyether, polyester, polyamide, ionomeric ethylene copolymer, polyolefin, poly-EPDM (ethylene-propylene-diene), styrene acrylonitrile copolymer, plasticized vinyl halide polymer, ABS copolymer or mixtures thereof) or may comprise a curable (cross-linkable) polymer such as those taught in U.S. Pat. No. 4,025,159, incorporated herein in its entirety. Some additional exemplary sealing layer materials are acrylic-based polymeric materials (e.g., acrylate or methylacrylate polymers or copolymers, polyethylene glycol diacrylates and hydroxymethyl diacetone acrylamide); and co-polyethylene terephthalate (COPET). Some additional exemplary sealing layer materials are described in, for example, U.S. Pat. No. 7,611,251, incorporated herein in its entirety. Some embodiments include a sealing layer including a thermoplastic comprising at least 50 wt-% reaction products of an alkylene monomer and reaction products of at least one non-acidic polar monomer, wherein the thermoplastic is modified by an acid, an anhydride, carbon monoxide, and/or a combination thereof. Some exemplary suitable copolymers for the sealing layer include copolymers of ethylene with vinyl acetate (EVA), acid- or anhydride-modified EVA's.

In some embodiments, the sealing layer material(s) softens sufficiently to flow under pressure at, for example, 75°-95° C. but remains substantially firm at temperatures below, for example, about 65° C. Some embodiments of the multilayer sealing film have a melt flow index of less than 25 g/10 min. as measured according to ASTM 1238.

In some embodiments, the sealing layer may itself comprise more than one layer. Such sealing films are taught in, for example, PCT publication WO 2011/152977 (incorporated herein in its entirety). In some embodiments, the multilayer sealing layer includes a first layer including a thermoplastic including reaction products of at least 50% of an alkylene and less than 25% non-acidic comonomer and a second layer including at least one of a polyolefin (e.g., polypropylene or high density polyethylene (HDPE)) and/or a polyester (e.g., polyethylene terephthalate (PET)), polymethyl methacrylate, polyamide, polycarbonate, ethylene-methacrylic acid copolymer, and/or polyurethane).

In some embodiments, the sealing layer includes colorants (e.g., whitening pigment such as titanium dioxide). If one layer of a multilayer sealing layer is pigmented, while another is transparent or clear, the transparent or clear layer may be closer to the polymeric web than the pigmented layer in laminating the sealing film to the polymeric web.

### Adhesive Layer

An adhesive layer also can be disposed behind the microspheres or the seal film to enable the retroreflective sheeting to be secured to a substrate. The adhesive layer may include any adhesive selected from a variety of formulations known in the art to achieve the desired combination of surface configuration and adhesion to a substrate. Examples include pressure sensitive adhesives (PSA's), including, for example, those described in U.S. Pat. Nos. 5,296,277; 5,362,516; and 5,141,790 and Satas, et. Al., Handbook of Pressure Sensitive Adhesives, 2^{nd} Ed. (Von Nostrand Reihnold, N.Y., 1989), all of which are incorporated by reference in their entirety. Additional exemplary adhesives include, for example, hot melt or heat activated adhesives that are pressure sensitive at the time of application such as PSA's disclosed in, for example, U.S. Pat. Nos. 4,994,322 and 4,968,562 as well as EPO Publication Nos. 540,515 and 617,708, all of which are incorporated herein in their entirety. Additional exemplary adhesives include, for example, a thermoplastic acrylic polymer, for example, an acid functional acrylic polymer. In some embodiments, the acid functional acrylic polymer includes about 10% acid (e.g., acrylic acid). One exemplary PSA composition includes a copolymer of isooctylacrylate and acrylic acid in a molar ratio of 95:5. Additional exemplary PSA compositions include cross-linked, tackified acrylic PSA's, blends of natural or synthetic rubber and resin, silicone or other polymeric compositions.

Chemistry and physical properties of the adhesive can be used to control the length of time the impression of the network of bonds will last in the adhesive layer after the release liner layer is removed. Understanding the rheological properties, such as creep resistance, of an adhesive can assist in controlling how quickly or if the channels may close after removal of the release liner layer and application of the adhesive-backed, retroreflective article to a substrate.

### Release Liner

Some embodiments include a release liner. Some embodiments do not include a release liner. For example, in some embodiments wherein the adhesive layer includes a PSA, a release liner may or may not be present. In some embodiments, the adhesive layer in not a PSA. In such embodiments, a release liner may or may not be present. In some embodiments, the adhesive is, for example, a hot melt (heat activated) adhesive. In some implementations of these embodiments, the multilayer sheet may include a sealing layer and adhesive without a release liner.

In some embodiments, the release liner (where present) includes a deformable polymer composition or metal foil, which performs at least one of the following: (1) it can be embossed to form the seal legs, (2) it will release from an embossing tool or roll, and (3) it will release from the adhesive layer so that the retroreflective article can be adhered to a substrate, such as a sign substrate. The release liner composition adequate for release from the adhesive may vary depending on the adhesive composition. In some embodiments, the release liner includes a blend of materials.

Exemplary release liner materials include, for example, polymeric materials. Some exemplary polymeric release liner materials include, for example, thermoplastics such as polyolefins (e.g., polypropylene, low density polyethylene, very low density polyethylene, and high density polyethylene), styrene copolymers, ethylene vinyl acetate polymers, polyurethanes, polydiorganosiloxane polyoxamide copolymers, polyesters (e.g., polyethylene terephthalate), copolyesters, polyvinyl chloride, Bynel acid/acrylate modified ethylene vinyl acetate polymers and Nucrel ethylene (meth)acrylic acid copolymers from E.I. DuPont de Nemours and Company, Wilmington, Del., Moplen HL 456J polypropylene composition from LyondellBasell Industries N.V., Houston, Tex., and Vistamaxx polypropylene based elastomer available from Exxon Mobil Corporation, Houston, Tex. Paper would not be a good choice for the release liner because of its relative inability to deform and withstand the process to form the seal legs.

In some embodiments, the release liner is made of multiple layers. In some embodiments, the multiple layers are coextruded. For example the release liner may include two layers (1) a release layer (e.g., very low density polyethylene) facing the adhesive layer and (2) an outer layer having a composition to reduce blocking (e.g., not very low density polyethylene). As used herein, the term “blocking” refer to an undesired adhesion between touching layers of a product (e.g., retroreflective sheeting that is rolled upon itself during storage). In some embodiments, very low density polyethylene has a density of less than 0.900 g/cm². In some embodiments, very low density polyethylene has a density of less than 0.890 g/cm². In some embodiments, very low density polyethylene has a density of less than 0.880 g/cm². In some embodiments, the outer layer includes at least one of polypropylene, polyethylene, or polyethylene terephthalate.

An exemplary polymer for use in a release liner made via co-extrusion is a plastomer, such as, for example, copolymers of ethylene and alpha-olefins having 3 to about 10 carbon atoms and a density no greater than 0.91 g/cc. or no greater than 0.89 g/cc (e.g., 1-butene, 1-hexene, 1-octene and combinations thereof). Copolymers of ethylene and 1-octene (block or random copolymers) are preferred for use with acrylate-based PSA's. Some useful copolymers are Infuse™ olefin block copolymers from Dow Chemical Company, Midland, Mich. and Exact™ ethylene alpha olefin copolymers from ExxonMobil. The release liner layer can include the layers described in PCT Publication WO 2011/091132 (which is incorporated herein in its entirety) as a release layer 30 (which can comprise a plastomer, e.g., a copolymer of ethylene and alpha-olefin such as 1-butene) and liner layer 32 (which can comprise a polyolefin, e.g., high density polyethylene and which can comprise more than one layer).

The release liner layer may be coated with one or more release agents such as silicone-based resins, urethanes, long chain acrylates, and fluorine-containing resins. Suitable release agents are described in, for example, U.S. Pat. Nos. 3,957,724; 4,567,073; and 5,290,615, and U.S. Patent Publication No. 2011/244226, all of which are incorporated herein in their entirety.

In at least some embodiments, the areas of the release liner layer into which channels are impressed do not recover their original or flat shape. In some embodiments, the areas of the release liner layer into which channels are impressed do recover their original or flat shape.

In some embodiments, a separate overlay film is on the viewing surface of the sheeting. The overlay film can assist in providing improved (e.g., outdoor) durability or to provide an image receptive surface. Indicative of such outdoor durability is maintaining sufficient brightness specifications such as called out in ASTM D49560-1a after extended durations of weathering (e.g., 1 year, 3 years).

Some exemplary substrates to which the retroreflective sheeting can be adhered include, for example, wood, aluminum sheeting, galvanized steel, polymeric materials (e.g., polymethyl methacrylates, polyesters, polyamids, polyvinyl fluorides, polycarbonates, polyvinyl chlorides, polyurethanes), and a wide variety of laminates made from these and other materials.

Some embodiments of the present disclosure are made by the following method: the beaded retroreflective sheeting and the multilayer film are brought together in a lamination process between an embossing tool (e.g., laminating roll) having a raised pattern in the desired seal pattern shape and a nip roll (or other means of providing pressure against the structured surface of the microspheres and multilayer film) under conditions of controlled pressure and temperature. Bonding and sealing between the sealing layer and the beaded retroreflective sheeting can be effected by thermal bonding, ultrasonic welding, ultraviolet radiation, ionizing radiation (such as, for example, electron beam radiation), radio frequency welding, and/or reactive components that develop a bond (see, for example, U.S. Pat. Nos. 5,706,132; 7,862,187; and 4,025,159, all of which are incorporated in their entirety herein). In embodiments in which the multilayer film has no release liner layer and the adhesive layer is facing the embossing tool, the tool may be made of a material that releases well from the adhesive layer and avoids depositing adhesive onto the embossing tool in excess. In some embodiments, the lamination process is controlled to obtain good bonding and sealing between the structured surface and the multilayer film by controlling such parameters as: embossing tool temperature, pressure between the nip roll and embossing tool (nip pressure), and/or speed of the webs through the process.

In some embodiments, the process involves laminating the entire multilayer film (including at least the adhesive layer and sealing layer) to portions of the structured surface (or microspheres) in a single step. This is advantageous over prior processes in which a seal film was laminated to a retroreflective element-containing film, an adhesive was placed on the seal film in a separate step, and then a release liner was applied to the construction in another separate step. The prior process required two or three separate steps whereas many embodiments of the improved process described herein involve only a single step. Application of adhesive and/or release liner separately from the seal film is more costly than a single-step process. So, the single-step process described herein confers manufacturing efficiency and cost-reduction while also potentially providing air egress.

In some embodiments, prior to lamination, an adhesion promoting surface treatment may be applied to either or both of the sealing layer (or multilayer film) or the structured surface. Some exemplary adhesion promotion treatments include, for example, corona treatment, flame treatment, radiation treatment, or application of a thin tie layer or priming layer.

In some embodiments, when the retroreflective article (e.g., sheeting) is to be applied to a substrate (e.g., a metal or plastic substrate for a traffic sign or license plate), the release liner layer (where present) is removed. In some embodiments, this exposes channels in the adhesive layer. These channels have the advantage that air egress (which may be called fluid exhaust or air bleed) from beneath the retroreflective sheeting is facilitated as the sheeting is applied to the substrate. This can help in reducing deformities in the applied sheeting such as air pockets, bubbles, or wrinkles. Retroreflective sheeting as described herein can be applied faster than other sheeting without channels in the adhesive layer because air bubbles and air pockets can be pressed out from beneath the sheeting.

All references mentioned herein are incorporated by reference in their entirety.

As used herein, the words “on” and “adjacent” cover both a layer being directly on and indirectly on something, with other layers possibly being located therebetween.

As used herein, the terms “major surface” and “major surfaces” refer to the surface(s) with the largest surface area on a three-dimensional shape having three sets of opposing surfaces.

Unless otherwise indicated, all numbers expressing feature sizes, amounts, and physical properties used in the present disclosure and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. All numerical ranges are inclusive of their endpoints and non-integral values between the endpoints unless otherwise stated.

As used in this specification and the appended claims, the singular forms “a”, “an”, and “the” encompass embodiments having plural referents, unless the content clearly dictates otherwise.

As used in this disclosure and the appended claims, the term “or” is generally employed in its sense including “and/or” unless the content clearly dictates otherwise.

The phrases “at least one of” and “comprises at least one of” followed by a list refers to any one of the items in the list and any combination of two or more items in the list.

Various embodiments and implementation of the present disclosure are disclosed. The disclosed embodiments are presented for purposes of illustration and not limitation. The implementations described above and other implementations are within the scope of the following claims. One skilled in the art will appreciate that the present disclosure can be practiced with embodiments and implementations other than those disclosed. Those having skill in the art will appreciate that many changes may be made to the details of the above-described embodiments and implementations without departing from the underlying principles thereof. It should be understood that this invention is not intended to be unduly limited by the illustrative embodiments and examples set forth herein and that such examples and embodiments are presented by way of example only with the scope of the invention intended to be limited only by the claims set forth herein as follows. Further, various modifications and alterations of the present disclosure will become apparent to those skilled in the art without departing from the spirit and scope of the present disclosure. The scope of the present application should, therefore, be determined only by the following claims.

1-26. (canceled)

27. A retroreflective article, comprising:
a plurality of microspheres that form a structured surface; and
a multilayer film comprising a polymeric sealing layer and an adhesive layer, the multilayer film adjacent to the structured surface; and
seal legs extending through all layers of the multilayer film and disposed between the structured surface and the multilayer film;
channels depressed in at least a portion of the multilayer film at the seal legs.

28. The retroreflective article of claim 27, wherein the microspheres are at least one of encapsulated, embedded, or exposed.

29. The retroreflective article of claim 27, further comprising:
a specular reflective layer adjacent to at least a portion of the micropsheres.

30. The retroreflective article of claim 27, wherein the channels are depressed in at least a portion of the adhesive.

31. The retroreflective article of claim 27, further comprising:
a release liner layer adjacent to the adhesive layer.

32. The retroreflective article of claim 31, wherein the multilayer film further comprises the release liner adjacent to the adhesive layer.

33. The retroreflective article of claim 32, wherein the channels are depressed in at least a portion of the adhesive and the release liner.

34. The retroreflective article of claim 31, wherein the release liner comprises a release layer facing the adhesive layer and an outer layer having a composition to reduce blocking.

35. The retroreflective article of claim 34, in which the outer layer includes at least one of polypropylene, polyethylene, or polyethylene terephthalate.

36. The retroreflective article of claim 31, wherein the release liner comprises a release layer comprising very low density polyethylene, and an outer layer comprising a polyethylene that is not very low density polyethylene.

37. The retroreflective article of claim 27, wherein the polymeric sealing layer includes at least one of a thermoplastic polymer, a heat activated polymer, a polymer composition curable by ultraviolet radiation, and a polymer composition curable by ionizing radiation.

38. A process of making a retroreflective article, comprising:
laminating the multilayer film to a plurality of microspheres and thereby forming a plurality of seal legs that extend through all layers of the multilayer film and forming channels depressed in at least a portion of the multilayer film at the seal legs;
wherein the multilayer film comprises a polymeric sealing layer and an adhesive layer.

39. The process of claim 38, wherein laminating the multilayer film includes bonding the multilayer film to the plurality of microspheres by at least one of ultrasonic welding, radio frequency welding, thermal bonding, ultraviolet radiation, and electron beam radiation.

40. The process of claim 38, further comprising:
forming the multilayer film using solution casting, extrusion casting, blown film extrusion, or any combination thereof.

41. The process of claim 38, wherein the microspheres are at least one of encapsulated, embedded, or exposed.

42. The process of claim 38, wherein the seal legs extend between the multilayer film and the microspheres.

43. The process of claim 38, wherein laminating the multilayer film adjacent to the plurality of microspheres forms an air interface between at least one of the microspheres and the multilayer film.

44. The process of claim 38, wherein the multilayer film further comprises a release liner layer adjacent to the adhesive layer.

45. The process of claim 44, wherein the release liner layer is comprised of two layers, a release layer facing the adhesive layer and an outer layer having a composition to reduce blocking.

46. The process of claim 44, wherein the release liner layer comprises a release layer comprised of very low density polyethylene, and an outer layer comprised of a polyethylene that is not very low density polyethylene.

47. The process of claim 21, wherein the outer layer includes at least one of polypropylene, polyethylene, or polyethylene terephthalate.

48. The process of claim 44, wherein the polymeric sealing layer includes at least one of a thermoplastic polymer, a heat activated polymer, a polymer composition curable by ultraviolet radiation, or a polymer composition curable by ionizing radiation.

49. The process of claim 44, further comprising:
co-extruding the sealing layer and adhesive layer to form the multilayer film.
